(19) United States
(12) Patent Application Publication
(10) Pub. No.: US 2005/0147940 A1
(43) Pub. Date: Jul. 7, 2005

(54) Foot control for dental instruments

(76) Inventor: James G. Mace, Washington, MO (US)

Correspondence Address: HUSCH & EPPENBERGER, LLC, 190 CARONDELET PLAZA, SUITE 600, ST. LOUIS, MO, 63105-3441, US

(21) Appl. No.: 10/752,850

(22) Filed: Jan. 7, 2004

(51) Int. Cl. A61C 1/02

(52) U.S. Cl. 433/101

(57) ABSTRACT

A foot control for a dental instrument includes a control signal generator and a foot-operated actuator to manually provide control information to the control signal generator. The control signal generator is responsive to the control information to generate and transmit an electromagnetic signal corresponding to the control information to a receiver associated with the dental instrument so as to control operation of the dental instrument. The control signal generator, the foot-operated actuator, and a power source are secured to a base adapted to rest on a floor of a dentist's office.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to a foot control for controlling the operation of dental instruments and, more particularly, to such a foot control that sends control signals electromagnetically.

2. Related Art

Various foot-operated controllers (foot controls) are known for controlling operating parameters of dental instruments, such as drills, scalers and the like. Typical foot controls include a single lever that controls the speed of an air-powered or electrically-powered handpiece. Single-lever foot controls suffer from the disadvantage that they may be actuated from essentially a single position, so that as the dental professional moves around the patient it may be necessary to move the foot control. In addition, dual-lever foot controls are available, but they suffer from essentially the same problem. Various attempts have been made to address this problem by, for example, providing an actuator for the foot control that may essentially be actuated from any position around the foot control. Currently there are available foot controls with a disk actuator (a low angle cone, disposed over the base of the foot control) that provides increased accessibility for the dental professional. Prior patents illustrating these concepts include U.S. Pat. Nos. 3,471,928; 4,041,609; 4,354,838; and 6,079,687, the disclosures of which are incorporated herein by reference. Although these devices work well, they could be improved.

It has been found that the cord connecting these prior art foot controls (often called “rheostats” in the art) to the dental instrument and its point of connection to the foot control itself pose problems for the dental professional operator. The cord, for example, usually runs from a cabinet behind the patient to the rheostat/foot control, and, therefore, lies between the dentist and the dental assistant on the floor. This space is often crowded and limited, due to casters, feet, and other cords. The operator (often the dentist) is constantly moving the rheostat as he or she changes positions. In addition, the design of many available foot controls dictates that the point of connection of the cord to the foot control (rheostat) is not usable by the operator's foot. This forces the operator to shift the foot control to a different position when the cord and its connection are “in the way.”

### SUMMARY OF THE INVENTION

Among the various features and advantages of the present invention may be noted the provision of an improved foot control that reduces clutter on the floor between the dental professional(s) and the patient.

Another feature is the provision of such a foot control that may be actuated from any position.

A third feature is the provision of such a foot control that operates in substantially the same manner as existing foot controls so that no additional training of the dental professional is required to operate the device.

A fourth feature is the provision of such a foot control that eliminates all cords, tubes, and cables from the foot control during operation.

In a first aspect of the present invention, a foot control for a dental instrument includes a control signal generator and a foot-operated actuator to manually provide control information to the control signal generator. The control signal generator is responsive to the control information to generate and transmit an electromagnetic signal corresponding to the control information to a receiver associated with the dental instrument so as to control operation of the dental instrument. A power source is provided for the control signal generator, and the control signal generator, foot-operated actuator, and power source are secured to a base adapted to rest on a floor of a dentist's office.

In a second aspect of the present invention, a cordless foot control for a dental instrument includes a base adapted to rest on a floor of a dentist's office, a foot-operated actuator (secured to the base such that the actuator is operable from any position around the actuator when the base is disposed on the floor) for providing control information, a power source, and a control signal generator connected to the power source and responsive to control information from the foot-operated actuator to generate and transmit an electromagnetic signal corresponding to the control information to a receiver associated with the dental instrument so as to control operation of the dental instrument.

In a third aspect of the present invention, a control system for a dental instrument includes a control signal generator, a foot-operated actuator to manually provide control information to the control signal generator, and a power source for the control signal generator. The control signal generator is responsive to the control information to generate and transmit an electromagnetic signal corresponding to the control information. The control signal generator, foot-operated actuator, and power source are secured to a base adapted to rest on a floor of a dentist's office. A receiver is provided for receiving the electromagnetic signal corresponding to the control information, said receiver being adapted to be operatively connected to said dental instrument, said receiver in response to receipt of said electromagnetic signal providing control information to the dental instrument.

In a fourth aspect of the present invention, a method of controlling a dental instrument includes the steps of manually actuating a cordless foot control disposed on a floor in the vicinity of the dental instrument to originate a control signal, electromagnetically transmitting the control signal to a receiver associated with the dental instrument, and controlling at least one operating parameter of dental instrument in response to the control signal created by the cordless foot control.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIGS. 1-3 illustrate a prior art foot control for a dental instrument;

FIG. 4 illustrates an improved foot control of the present invention;

FIG. 5 illustrates a receiver used with the improved foot control of the present invention;

FIG. 6 illustrates a top view of the foot control of FIG. 4;

FIG. 7 illustrates a bottom view of the foot control of FIG. 4;

FIG. 8 illustrates a view of the foot control of FIG. 4 with parts broken away for clarity;

FIG. 9 illustrates a front view of the receiver of FIG. 5;

FIG. 10 illustrates a rear view of the receiver of FIG. 5 used with an air-powered dental instrument;

FIG. 11 illustrates a cross-sectional view of the receiver of FIG. 10;

FIG. 12 illustrates a rear view of the receiver of FIG. 5 used with an electrically-powered dental instrument; and

FIG. 13 illustrates a cross-sectional view of the receiver of FIG. 12.

Similar reference characters indicate similar parts throughout the several views of the drawings.

### DETAILED DESCRIPTION OF THE PREFERRED EMBODIMENTS

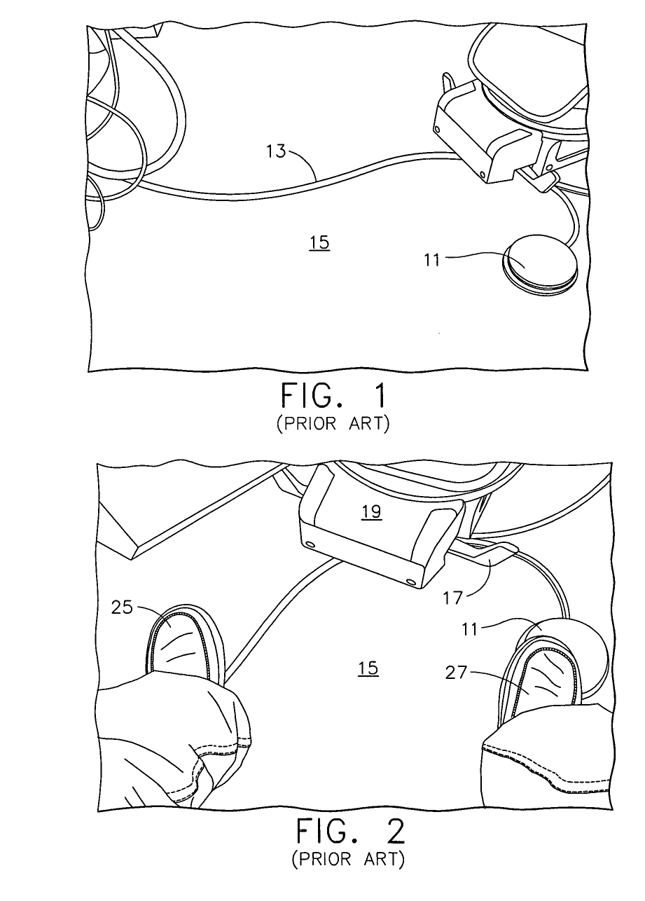

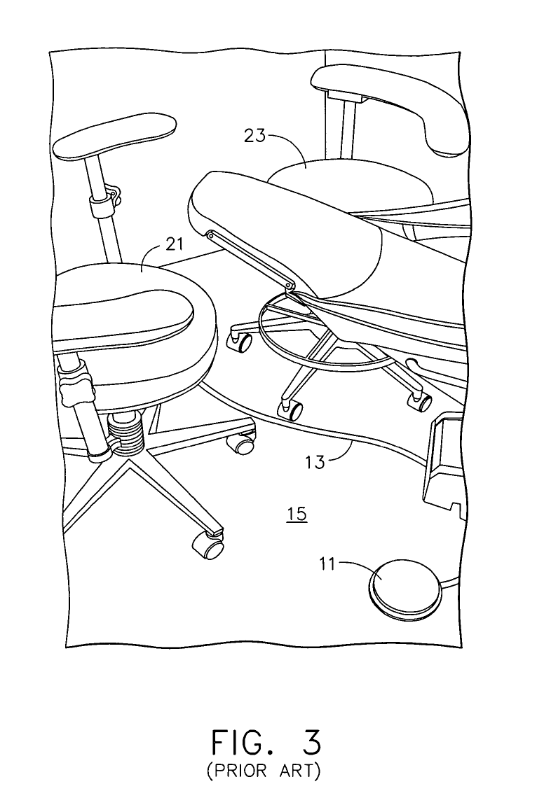

Referring to the accompanying drawings in which like reference numbers indicate like elements, FIG. 1 illustrates a prior art foot control (rheostat) 11 connected to a dental instrument (not shown) by a cable or tube 13 (depending upon whether the dental instrument is air-powered or electrically powered). As seen in FIGS. 1-3, the cable/tube stretches across the floor 15 of the dentist's office, potentially interfering with a control lever 17 of the patient's chair 19, with free movement of the dentist's chair 21, or with free movement of the dental hygienist's chair 23. FIG. 2 illustrates, for example, the cable/tube interfering with the placement of the dentist's left foot 25 while the right foot 27 is operating the prior art foot control.

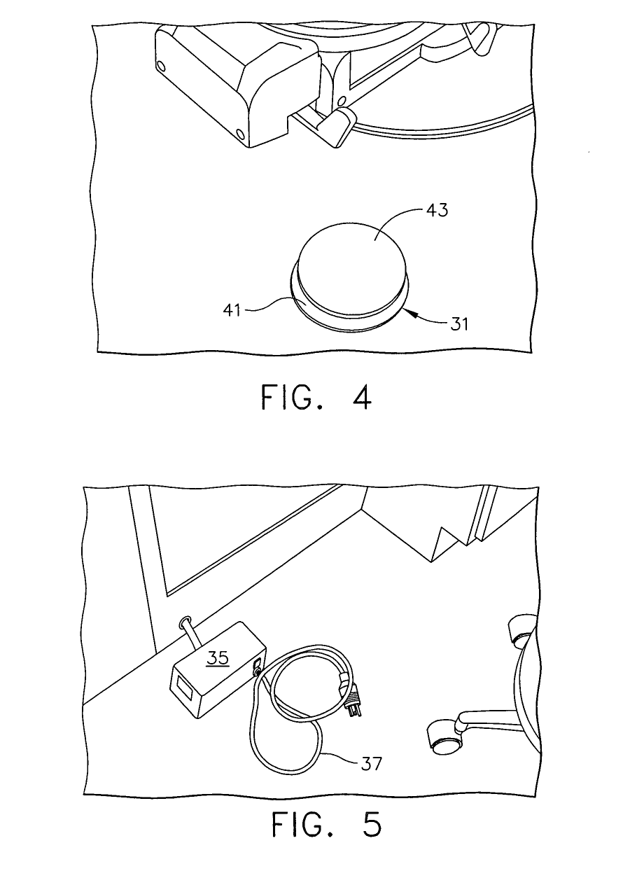

In FIGS. 4 and 5, a replacement foot control (rheostat) 31 for prior art foot control 11 is shown. Foot control 31 is cordless—the cable/tube 13 of the prior art device is eliminated. As is explained in detail below, foot control 31 of the present invention is responsive to actuation by the dental professional's foot to electromagnetically send a control signal to a receiver 35 (FIG. 5). Receiver 35 may be powered by a suitable power cord 37, since the receiver may be located in an out-of-the-way location. Receiver 35 in response to the electromagnetic control signal controls operation of the dental instrument (again as described in detail below). This combination of a foot control 31 that generates an electromagnetic control signal and a receiver 35 disposed in a location that does not interfere with the dental procedure being performed overcomes the various problems identified above with respect to the prior art devices.

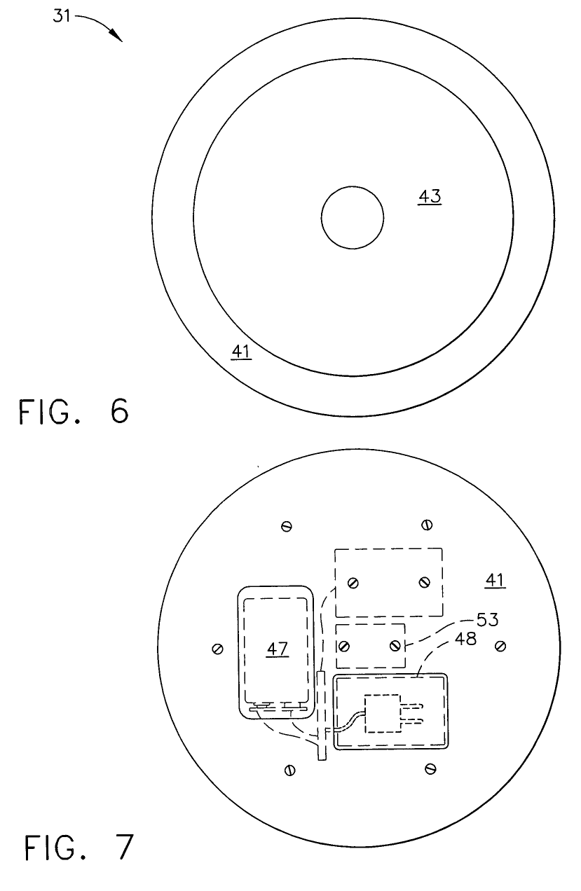

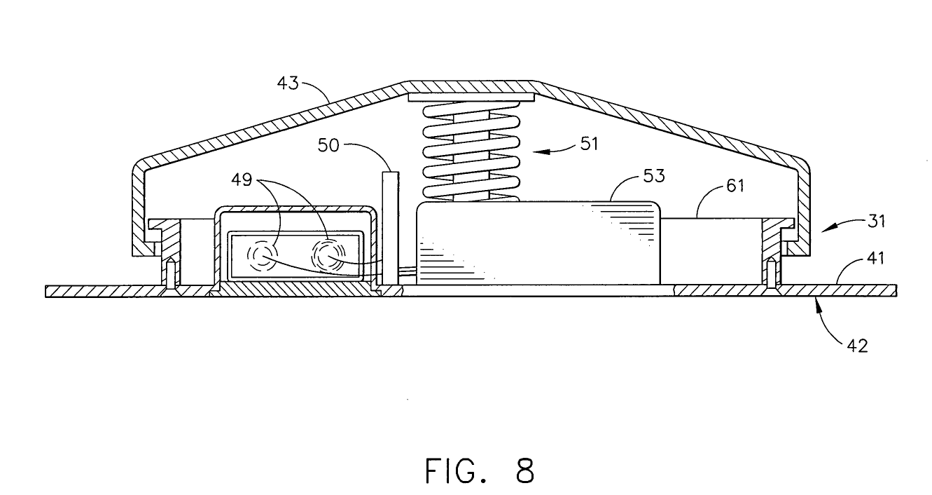

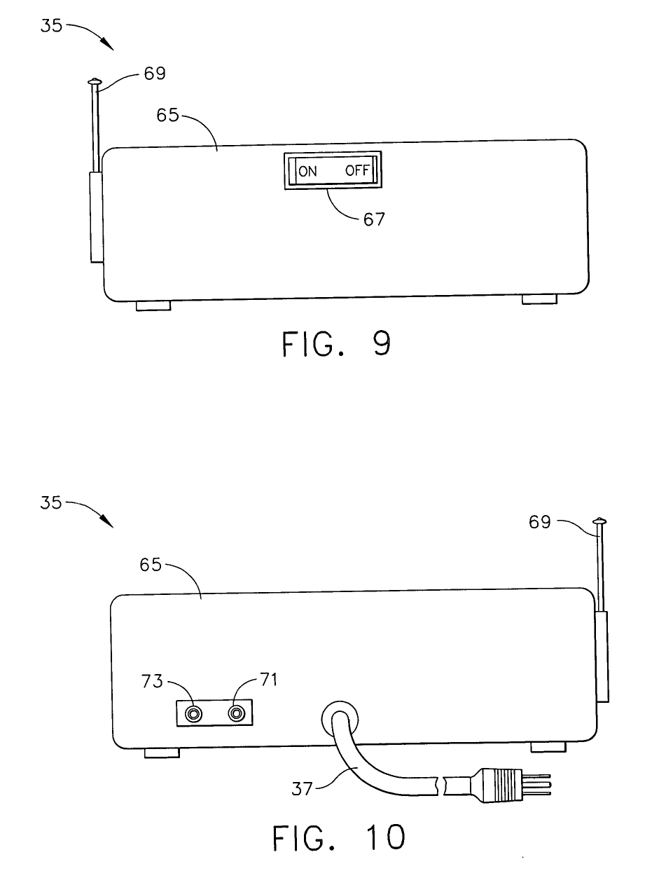

Turning to FIGS. 6-8, the foot control 31 of the present invention is seen to include a base 41 having a substantially flat bottom surface 42 (see FIG. 8) suitable for resting flat on the floor of a dentist's office. A foot-operated actuator 43 is disposed above the base in a position to be actuated in any direction by the dental professional. Note that foot control 31, since it has no exposed cables/tubes, truly provides 360° operation. As can be seen most clearly in FIG. 7, base 41 includes a door 47 which covers a number of batteries 49 (FIG. 8) that power the electronics of the foot control 31. If desired, a retractable plug 48 may optionally be included in the foot control. Plug 48 may be used with an optional charger circuit 50 (shown in block form in FIG. 8) to charge batteries 49 when the unit is not in use. Also shown in FIG. 7 are a plurality of screws or other appropriate fasteners that may be used to secure base 41 to the remainder of foot control 31.

Foot-operated actuator 43 may have any shape, including the conventional disk-like shape shown in FIGS. 6 and 8. As shown in FIG. 8, actuator 43 is connected by a spring-loaded plunger 51 to a control signal generator 53. As the plunger is depressed, the control signal generator generates an electromagnetic signal. In the case of a variable speed dental instrument, the amount the plunger 51 is depressed is reflected correspondingly in the signal generated by control signal generator 53.

The particular manner in which the control information from the foot-operated actuator 43 is encoded into the electromagnetic signal from the control signal generator is not a limitation on the present invention—all such manners of encoding are intended to be included within the scope of the present inventions. By way of illustration, amplitude modulated signals, frequency modulated signals, and digital signals are all intended to be included. Similarly, the actual manner in which such signals are generated is not considered to be a significant portion of the present invention, since the generation of electromagnetic signals (throughout the frequency range of such signals) to convey desired information is well-known.

As is also shown in FIG. 8, a frame 61 is attached by suitable fasteners to base 41 and holds the batteries 49, the control signal generator 53 and the actuator 43 in place. Significantly, foot control 31 is self-contained. Unlike the prior art it has no external wires or tubes to interfere with the equipment or with the dental professionals during a dental procedure.

It should be understood that foot control 31 may be used (without modification) for either air-powered or electrical-powered dental instruments. Receiver 35, however, must be modified, depending upon the type of power. In the description that follows it should be realized that the particular placement of the various components of receiver 35 is a matter of choice and does not limit the present invention in any way. In the particular configuration illustrated, the front of receiver 35 is the same for both air-powered and electrically-powered dental instruments. Each receiver includes a housing 65, and an on/off switch 67, and an antenna 69. (Of course, depending upon the frequencies involved, the antenna may be shaped differently, may be disposed differently, etc. In some configurations, it is believed that the antenna as a separate part may be omitted entirely).

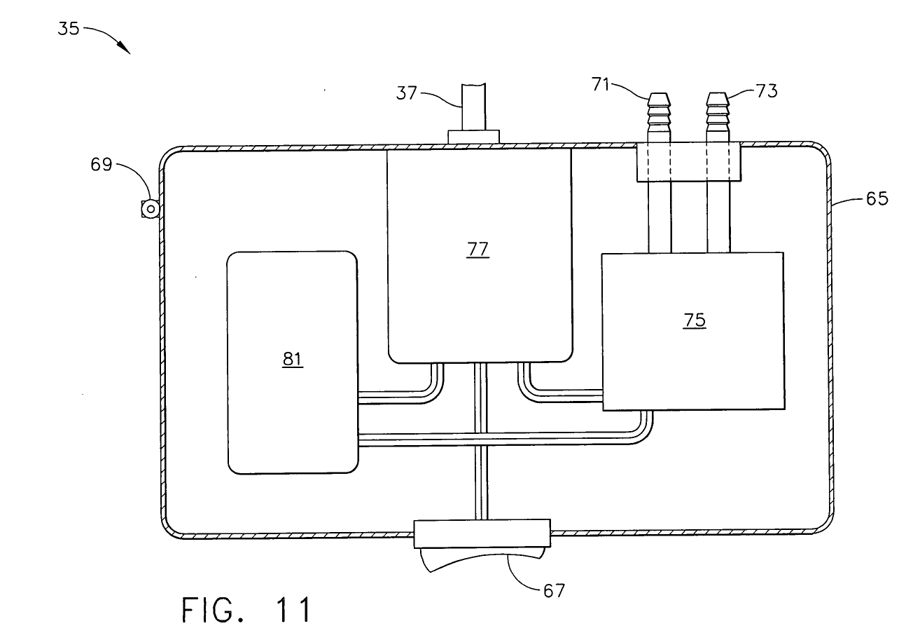

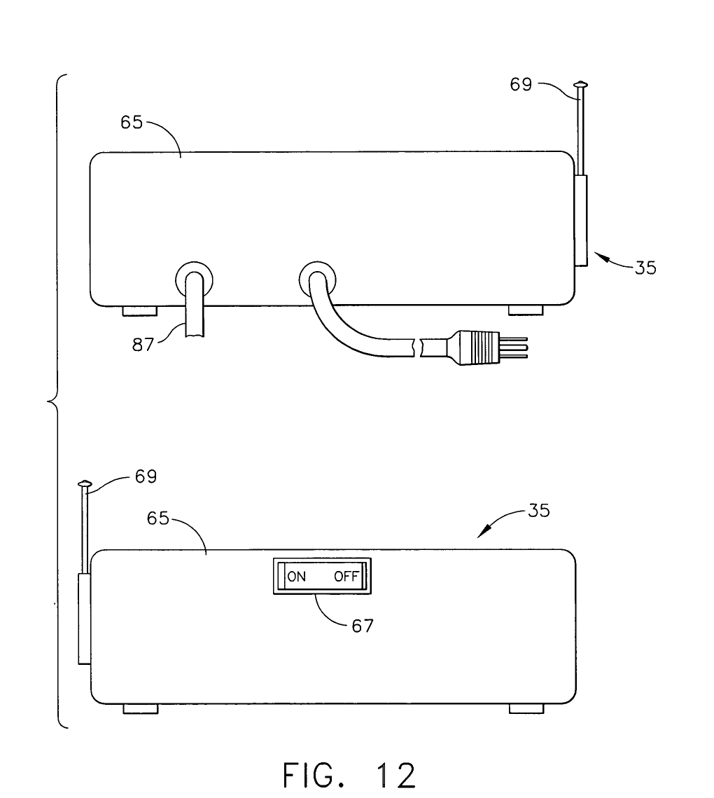

For air-powered dental instruments, a possible configuration of receiver 35 is illustrated in FIGS. 10 and 11. In this case, receiver 35 includes inlet and outlet air line connectors 71, 73 connected to a valve control box 75 (FIG. 11). Controls for pneumatic systems are, of course, well-known, and it is contemplated that the present invention may use any desired pneumatic control system for valve control box 75. Receiver 35 also includes a power supply 77 connected to switch 67, valve control box 75 and an electromagnetic signal receiver circuit 81. (Although a radio receiver circuit is shown, any electromagnetic signal receiver may be used.) The electromagnetic signal from foot control 31 is received (via antenna 69) by receiver circuit 81, which supplies control information based upon the received signal to conventional circuitry in valve control box 75 to control the air supplied to the dental instrument in amounts corresponding to the control signal.

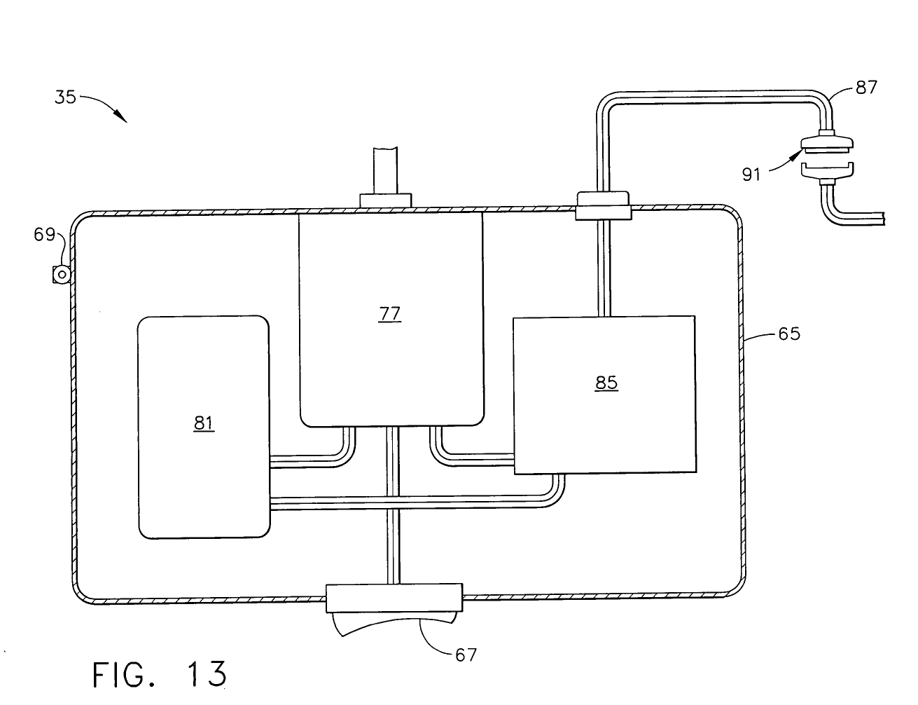

For an electrically-powered dental instrument (illustrated in FIGS. 12 and 13), the valve control box and air-line connectors are replaced by a signal converter box 85 and an electrical control wire 87. In addition, if the output of the signal converter box 85 is not compatible with the dental instrument, an adapter 91 may be included. It is preferred that the adapter not be needed, and the requisite electrical requirements be satisfied by the signal converter box itself. The electromagnetic control signal in this situation is received by receiver circuitry 81 and signal converter box 85 converts the control information into the form required by the dental instrument.

Numerous variations of the apparatus described above may fall within the scope of the present invention. For example, when several foot controls of the present invention are used in a single office, systems similar to those used for garage door openers may be implemented to keep the foot controls from interfering with each other. (Of course, the frequencies used should be selected as well so as not to interfere with other electrical equipment within range.) It should also be appreciated that the present invention is particularly well-suited for use in retrofitting existing dental instrument control systems. For example, in the case of air-powered systems, the air lines currently attached to the prior art foot controls can simply be shortened and connected directly to the rear of the receiver unit.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A foot control for a dental instrument comprising:
a control signal generator;
a foot-operated actuator to manually provide control information to the control signal generator;
said control signal generator being responsive to the control information to generate and transmit an electromagnetic signal corresponding to the control information to a receiver associated with the dental instrument so as to control operation of the dental instrument;
a power source for the control signal generator;
said control signal generator, foot-operated actuator, and power source being secured to a base adapted to rest on a floor of a dentist's office.

2. The foot control as set forth in claim 1 wherein the base is free of external power cords, external cables, and external tubes, whereby the foot control has no cords or tubes to interfere with movement of a dentist using the dental instrument during a dental procedure.

3. The foot control as set forth in claim 1 wherein the foot-operated actuator is symmetrical and is operable to provide said control information from any position around the actuator when the base is disposed on the floor.

4. The foot control as set forth in claim 1 wherein the dental instrument is air-operated, the receiver being adapted to control air flow to the dental instrument by controlling air flow from a regulator to the dental instrument.

5. The foot control as set forth in claim 1 wherein the dental instrument is electrically powered and the receiver is adapted to control the speed of the dental instrument by varying electrical characteristics of electrical power supplied to the dental instrument.

6. The foot control as set forth in claim 1 wherein the power source includes a rechargeable battery.

7. The foot control as set forth in claim 6 further including a retractable electrical plug entirely disposed under the foot-operated actuator during use of the foot-operated actuator.

8. The foot control as set forth in claim 1 wherein the electromagnetic signal is adapted not to interfere with other equipment, including other foot controls in a dentist's office.

9. The foot control as set forth in claim 1 wherein the electromagnetic signal is varied in accordance with variation in the control information from the foot-operated actuator, whereby a dentist may vary the speed of operation of the dental instrument by varying the force applied to the foot-operated actuator.

10. A cordless foot control for a dental instrument comprising:
a base adapted to rest on a floor of a dentist's office;
a foot-operated actuator, secured to the base such that the actuator is operable from any position around the actuator when the base is disposed on the floor, for providing control information;
a power source; and
a control signal generator connected to the power source and responsive to control information from the foot-operated actuator to generate and transmit an electromagnetic signal corresponding to the control information to a receiver associated with the dental instrument so as to control operation of the dental instrument.

11. The cordless foot control as set forth in claim 10 wherein said control signal generator, foot-operated actuator, and power source are secured to a base adapted to rest on a floor of a dentist's office.

12. The foot control as set forth in claim 10 wherein the base is free of external power cords, external cables, and external tubes, whereby the foot control has no cords or tubes to interfere with movement of a dentist using the dental instrument during a dental procedure.

13. The foot control as set forth in claim 10 wherein the foot-operated actuator is symmetrical.

14. The foot control as set forth in claim 10 wherein the dental instrument is air-operated, the receiver being adapted to control air flow to the dental instrument by controlling air flow from a regulator to the dental instrument.

15. The foot control as set forth in claim 10 wherein the dental instrument is electrically powered and the receiver is adapted to control the speed of the dental instrument by varying electrical characteristics of electrical power supplied to the dental instrument.

16. The foot control as set forth in claim 10 wherein the power source includes a rechargeable battery.

17. The foot control as set forth in claim 16 further including a retractable electrical plug entirely disposed under the foot-operated actuator during use of the foot-operated actuator.

18. The foot control as set forth in claim 10 wherein the electromagnetic signal is adapted not to interfere with other equipment, including other foot controls in a dentist's office.

19. The foot control as set forth in claim 10 wherein the electromagnetic signal is varied in accordance with variation in the control information from the foot-operated actuator, whereby a dentist may vary the speed of operation of the dental instrument by varying the force applied to the foot-operated actuator.

20. A control system for a dental instrument comprising:
a control signal generator;
a foot-operated actuator to manually provide control information to the control signal generator;
said control signal generator being responsive to the control information to generate and transmit an electromagnetic signal corresponding to the control information;
a power source for the control signal generator;
said control signal generator, foot-operated actuator, and power source being secured to a base adapted to rest on a floor of a dentist's office;
a receiver for receiving the electromagnetic signal corresponding to the control information, said receiver being adapted to be operatively connected to said dental instrument, said receiver in response to receipt of said electromagnetic signal providing control information to the dental instrument.

21. A method of controlling a dental instrument comprising:
manually actuating a cordless foot control disposed on a floor in the vicinity of the dental instrument to originate a control signal;
electromagnetically transmitting the control signal to a receiver associated with the dental instrument;
controlling at least one operating parameter of dental instrument in response to the control signal created by the cordless foot control.

22. The method as set forth in claim 21 wherein the dental instrument is air-powered, and wherein the operating parameter of the dental instrument is controlled by controlling the air supplied to the dental instrument in response to the control signal.

23. The method as set forth in claim 21 wherein the dental instrument is electrically powered, and wherein the operating parameter of the dental instrument is controlled by controlling the electrical power supplied to the dental instrument in response to the control signal.

24. The method as set forth in claim 21 wherein the dental instrument is a variable-speed instrument, the control signal being varied by manipulation of the cordless foot control to correspondingly vary the speed of the dental instrument.
